(19) United States
(12) Patent Application Publication
(10) Pub. No.: US 2021/0280838 A1
(43) Pub. Date: Sep. 9, 2021

(54) CONFIGURING AND MAINTAINING SHINGLED OVERLAPS OF ELECTRODE EXTENSIONS AT END PLATE OF JELLY ROLL OF BATTERY MATERIALS

(71) Applicant: James E. Beecham, West Palm Beach, FL (US)

(72) Inventor: James E. Beecham, West Palm Beach, FL (US)

(21) Appl. No.: 17/102,226

(22) Filed: Nov. 23, 2020

Related U.S. Application Data
(63) Continuation-in-part of application No. 17/092,035, filed on Nov. 6, 2020.
Application No. 17/092,035 is a continuation-in-part of application No. 17/064,243, filed on Oct. 6, 2020.
Application No. 17/064,243 is a continuation-in-part of application No. 17/033,853, filed on Sep. 27, 2020.
Application No. 17/033,853 is a continuation-in-part of application No. 16/867,273, filed on May 5, 2020, now Pat. No. 10,800,434.
(60) Provisional application No. 62/986,682, filed on Mar. 7, 2020.

(51) Int. Cl. H01M 2/26

(52) U.S. Cl. CPC H01M 2/26

(57) ABSTRACT

Instant invention comprises configuring end plate of jelly roll of battery materials. Said end, said end plate configured to typically comprise at least twelve electrode extensions in face-to-face shingled tight overlaps. Said end plate is further configured to typically comprise fold-over tabs at periphery of end plate, such tabs when folded over, useful for seeming the compactness of the end plate's face-to-face shingled tight overlaps of electrode extensions, thus promoting battery efficiency during useful life of battery.

### CROSS-REFERENCE TO RELATED APPLICATION

The present invention claims priority to non-provisional application Ser. No. 17/092,035 filed 6 Nov. 2020 by instant inventor, entitled ELECTRODE EXTENSION OVERLAP CONFIGURATIONS IN BATTERY, which claims priority to non-provisional application Ser. No. 17/064,243 filed 6 Oct. 2020 by instant inventor, entitled ELECTRIC VEHICLE BATTERY PACKS COMPRISING TABLESS/MULTI-TAB CYLINDRICAL JELLY-ROLL STYLE BATTERY CELLS, which claims priority to non-provisional application Ser. No. 17/033,853 filed 27 Sep. 2020 by instant inventor, entitled ELECTRIC VEHICLE SAFETY AS TO SIDE COLLISIONS AND BATTERY PACK PLACEMENT IN MANUFACTURING, which claims priority to non-provisional application Ser. No. 16/867,273 filed 5 May 2020 by instant inventor, entitled A METHOD AND SYSTEM FOR MITIGATING ANTICIPATED RISKS IN SELF-DRIVING VEHICLES VIA USE OF MALICIOUS ROADWAY FALSIFIED APPEARANCES now issued U.S. Pat. No. 10,800,434 of 13 Oct. 2020, which claims priority to provisional application Ser. No. 62/2986682 filed Mar. 7, 2020, hereby each referenced publication is incorporated in its et at least by reference.

### FIELD OF THE INVENTION

The present invention generally relates to batteries. More specifically, the present invention relates to end plates of jelly roll of battery materials.

### BRIEF SUMMARY OF THE INVENTION

In a preferred embodiment, multiple extensions arising along one edge of metal foil electrode, each comprise rectangular flat portions of conductive material. In a preferred embodiment, said electrode is within jelly roll of battery materials. In a preferred embodiment, end plate of said jelly roll of battery materials is assembled by winding said battery materials around a central axis.

In a preferred embodiment, said end plate is located at one end of cylinder of wound jelly roll of battery materials. In a preferred embodiment, said end plate comprises compact assembly of face-to-face shingled overlapping electrode extensions. As to definitions, a face of an electrode extension is herein defined as one of the flat sides of an electrode extension, as opposed to edge of electrode extension. Face-to-face overlap of an electrode extension is herein defined as a flat surface or face of a first electrode extension directly applied to, i.e. overlapped as a shingle onto, a flat surface of at least one other electrode extension.

It is understood that a battery supplies energy to an external circuit via electron flow. In a preferred embodiment, assembly of compact end plate at end of jelly roll of battery materials facilitates such energy supply to external circuit. In a preferred embodiment, such energy supply comprises electron flow enabled by electron pathways comprised in compact end plate. Said electron pathways are enabled by maintaining the compactness of the end plate. The integrity of the end plate electrical connections, such as those comprised in face-to-face shingled overlaps of electrode extensions, is maintained by compactness of the end plate.

In a preferred embodiment, assembled end plate is enabled to maintain its compactness by means herein disclosed. Said compactness secures electrical connections and electron paths, such as between end plate's electrode extensions and the battery cap.

In a preferred embodiment, such compactness is secured at least by fold-over tabs applied at the periphery of the end plate. In a preferred embodiment, said fold-over tabs are comprised in connection to a circumferential band of metal applied to end plate. Such tabs are in effect extensions, but for sake of clarity, the term tab will be used herein for these fold-over elements.

In a preferred embodiment, said fold-over tabs arise from and comprise a circumferential band of metal surrounding the jelly roll end plate. It is understood that such a band can be affixed as a single part to said end plate. Optionally the affixing of circumferential band can start with band disposed as two parts. One part each from opposite sides of end plate can be applied, then joined. In a preferred embodiment, placement of said hand is guided by automated machine, optionally laser enabled.

In a preferred embodiment, said halves of band are joined at end plate and locked into place via use of automated crimping machine. In a preferred embodiment, said crimping secures together the two parts of the band at the end plate, by overlapping of fold-over tabs from one half of the band onto fold-over tabs of other half. Such interlocking of tabs secures band into place at end plate in the two-piece band configuration.

In a preferred embodiment, the circumferential band is comprised as part of a full jacket or cylindrical case into which the jelly roll after winding is placed. Said folded over tabs of circumferential band, whether comprised as a free-standing band or part of a jacket or cylindrical case, extend over top of end plate periphery when folded over, there serving to maintain the integrity of electrical connections within, and compactness of, the end plate. In a preferred embodiment, such maintaining preserves the face-to-face shingle overlapping of the end plate electrode extensions. In a preferred embodiment, such maintaining preserves the electron paths for end plate to external circuit. Maintaining a plurality of electron paths within a battery mitigates against overheating of battery.

U.S. Pat. No. 10,800,434 to Beecham is herein incorporated in its entirety, at least by reference.

### BRIEF DESCRIPTION OF THE FIGURES

Other features and advantages of the present invention will become apparent when the following detailed description is read in conjunction with the accompanying drawings, in which:

FIG. 1 is a schematic illustrating details of a preferred embodiment

FIG. 2 is a schematic illustrating details of a preferred embodiment.

### DETAILED DESCRIPTION OF PREFERRED EMBODIMENTS

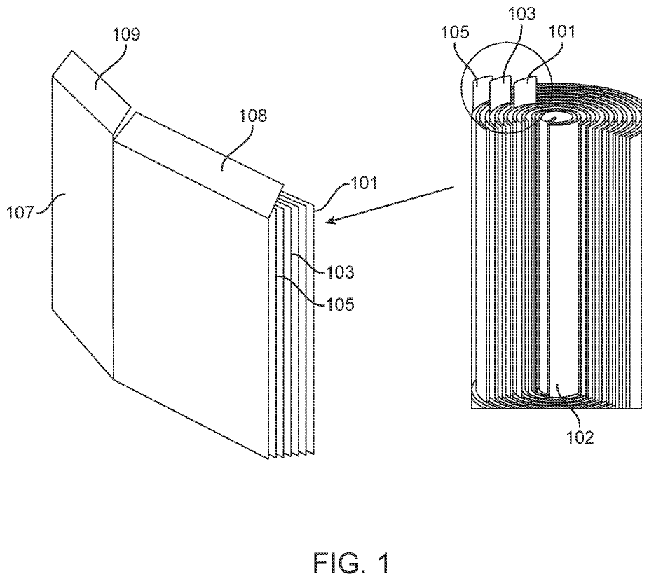

In FIG. 1, a preferred embodiment of instant invention is schematically illustrated, comprising a jelly roll of battery materials shown in cut-away 102. The jelly roll comprises a first electrode comprising at least twelve electrode extensions, of which three are illustrated 101, 103, 105. These three extensions by illustration, enable the understanding of mechanisms which affect all electrode extensions within the jelly roll and within the compact end plate.

In FIG. 1 at left, the nature of the overlapping of end plate's electrode extensions after winding of jelly roll is illustrated by the closeness of the six stacked layers which include 101, 103 and 105. Although only six of at least twelve face-to-face overlapped electrode extensions are illustrated, it is understood that these six represent the typical at least twelve, and typically many more, such as up to one hundred or more, of compacted electrode extensions typically present within instant invention end plate of a jelly roll of battery materials. It is to be understood that the alignment of the ends of these electrode extensions drawn in this illustration is not applicable to the actual circumstance in the end plate. Such alignment of overlapped electrode extensions at end view in FIG. 1 is only an artifice of the illustration, to enable numbering.

Continuing at the left side of FIG. 1, a portion of a circumferential band 107 is illustrated. Said band secures the compactness of the jelly roll end plate after winding. Said band comprises at least seven tabs, of which two are illustrated 108 and 109. Said tabs, when folded over the peripheral aspect of the end plate, assist in securing in place the compactness of end plate, and the relative positions of the shingled tightly overlapped electrode extensions.

The band with its at least seven tabs of fold-over type, when applied to the periphery of the top of the end plate, secure the end plate from unraveling. The compactness of the end plate thus secured in place by said tabs and circumferential band, said compactness enables maintaining of end plate's face-tip-face shingled overlaps of electrode extensions. Said compactness further assists in maintaining the overlapped extensions' associated electron paths. In a preferred embodiment, machinery (not shown) enables automated attachment of said band to the end plate. In a preferred embodiment, said automated application to end plate of the band, comprises folding over on the end plate periphery the at least seven tabs of fold-over type.

It a preferred embodiment, the most peripheral extensions on the jelly roll comprise the said fold-over tabs, rather than said tabs arising from a separate circumferential band. In a preferred embodiment, said most peripheral at least seven electrode extensions serving as said tabs, when folded over top of end plate at its periphery, accomplish the securing of compactness of end plate, and accomplish the maintaining of electron paths within end plate. In a preferred embodiment, said fold-over tabs, in maintaining of end plate compactness and face-to-face overlaps of electrode extensions, promote the useful life of the battery while mitigating against heat buildup during battery operations. Such maintaining of compactness and electrical connection integrity, whether by circumferential band or by use as fold-over tabs of extensions of electrode, such maintaining is to the benefit of efficiency of battery during useful life.

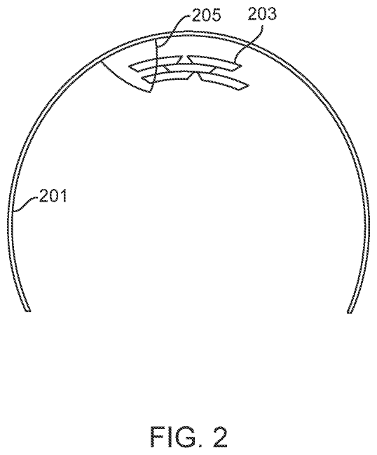

It is to be understood that the illustrated uniformity of alignment of ends of overlapped electrode extensions, at left side of FIG. 1, as illustrated for the six end-aligned electrode extensions, is not typically present within instant invention end plate. FIG. 2 illustrates the typical alignment.

In FIG. 2, a preferred embodiment comprises the peripheral circumferential band 201 comprised of fold-over tab 205. The band is drawn as a partial circumference element, however in a preferred embodiment the band is fully circumferential. Tabs of instant invention are typically comprised of solid metal. The tab drawn in FIG. 2 is illustrated as shape outline with transparent interior, so viewer may see the underlying electrode extensions 203. It is understood that the typical circumferential band comprises fold-over tads around the full perimeter of the end plate, and that the one tab drawn here is for illustrative purposes. Five of the electrode extensions are illustrated in FIG. 2 for purposes of exemplifying at least some features in common with other electrode extensions in end plate. In a typical end plate of instant invention the compacted end plate has a surface comprised throughout, excepting the central axis of winding area, of closely compacted electrode extensions presenting to view from above as the five illustrated electrode extensions drawn present, i.e. a more or less dense compaction of ends of electrode extensions in overlap. Electrode extensions at 203 are disposed in typical tightly shingled face-to-face overlap as viewed from above jelly roll in this schematic. The five electrode extensions are compacted to tight approximation, one to the other, within end plate, as would be the case of tight approximation for all electrode extensions of end plate. The central electrode of the five is overlapped in its front face and back face by multiple electrode extensions. The electrode extensions comprise their typical slightly curved form. The close fitting of these five electrode extensions illustrates the close fit expected between at least a majority of the end plate's electrode extensions. Due to the close approximation of neighboring electrode extensions, electron paths are enabled between and among thein. The extensions can be said to have two flat surfaces or faces, herein termed front and back. In a preferred embodiment, as illustrated in FIG. 2, within end plate of instant invention it is common, especially in portion of end plate away from center, for an electrode extension to overlap by its front face, one or two faces of other extensions within the compactly wound end plate, and to overlap by its back face, one or two faces of other extensions within the end plate. Such close face-to-face shingled tight overlapping, as illustrated in FIG. 2, enables compactness and promotes secure electrical connections.

In a preferred embodiment, at least one step in the sequence of battery assembly of instant invention is enabled by machinery. For example, the winding of jelly rolls of instant invention is performed typically by at least one machine comprised of a motorized bobbin. Furthermore, for example, the end plate comprised from such winding receives circumferential band by machine-enabled attaching. Furthermore, for example, the folding down of the peripheral fold-over tabs, whether tabs of a circumferential band or tabs of jelly roll electrode extension type, said folding down is typically enabled by machine, as is the attaching of a band if used.

In a preferred embodiment, essentially the full periphery of end plate circumferential band is endowed with fold-over tabs. Although the fold-over tabs in FIG. 1 are illustrated as rectangular 108 and 109, it is understood that such tabs can be angled, as illustrated in FIG. 2. Such angled arrangement can assist tabs to obtain secure grip for assuring the compactness of the end plate and its maintaining.

Although the invention has been described in considerable detail in language specific to structural features, and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated and can be made without departing from the spirit and scope of the invention.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

What is claimed is:

1-20. (canceled)

21. An end plate of jelly roll of battery materials comprising compact assembly of face-to-face in-contact shingle-overlapping electrode extensions wherein at least one electrode extension receives face-to-face snug contact shingle overlaps from at least three extensions within said end plate.

22. The end plate of claim 21 wherein said at least four extensions comprising said shingle overlaps comprise electrical connections.

23. The end plate of claim 22 wherein at least one tab applied at periphery of said end plate at least contributes to maintaining said electrical connections.

24. The end plate of claim 23 wherein said at least one peripheral tab comprises at least one of list: arising as extension of electrode, comprising peripheral band, comprising jacket, comprising cylindrical case.

25. A method of configuring end plate of jelly roll of battery materials comprising step of assembling face-to-face in-contact shingle-overlapping electrode extensions into compact end plate, said end plate wherein at least one electrode extension receives face-to-face snug contact overlaps from at least three extensions within end plate.

26. The method of claim 25 further comprising step of establishing mutual electrical connections to comprise said at least four shingle overlapped electrode extensions.

27. The method of claim 26 further comprising step of applying tab at periphery of said end plate wherein said applied tab at least contributes to maintaining said mutual electrical connections.

28. The method of claim 27 further comprising step of preserving said overlaps as snug during battery operations.

29. The method of claim 28 further comprising step of said end plate assembling enabled at least in part by at least semi-automation.

30. The method of claim 29 further comprising step of folding-down of tabs around full periphery of said end plate.

31. The method of claim 30 further comprising step of said folding down of peripheral tabs at least in part by machine enablement.

32. A jelly roll of battery materials end plate comprising at least five hundred extensions of an electrode, each of said at least five hundred extensions comprising within said end plate each at least one face-to-face shingled overlap to another extension assembled within said end plate.

33. The end plate of claim 32 further comprising at least a majority of said end plate's electrode extensions as shingle face-to-face overlapped with at least two extensions.

34. The jelly roll end plate of claim 33 wherein at least a majority of circumference of end plate periphery comprises folded-down tabs.

35. The jelly roll end plate of claim 34 wherein assembly is at least partially machine enabled.

36. The jelly roll end plate of claim 35 wherein snugness of said overlaps is maintained during battery use.
